(19) United States
(12) Patent Application Publication
(10) Pub. No.: US 2026/0061949 A1
(43) Pub. Date: Mar. 5, 2026

(54) FRESH WATER RECLAMATION SYSTEM FOR RECREATIONAL VEHICLES

(71) Applicant: Epiphany RV Systems, LLC, Middlebury, IN (US)

(72) Inventors: Jonathan James Ellis, Elkhart, IN (US); Eric Bruning, Middlebury, IN (US); Benjamin Jacques, Holland, MI (US)

(73) Assignee: Epiphany RV Systems, LLC, Middlebury, IN (US)

(21) Appl. No.: 19/232,393

(22) Filed: Jun. 9, 2025

Related U.S. Application Data
(60) Provisional application No. 63/668,551, filed on Jul. 8, 2024.

(51) Int. Cl. B60R 15/00

(52) U.S. Cl. CPC B60R 15/00

(57) ABSTRACT

A water supply system for conserving water for a recreational vehicle is disclosed herein. The water supply system includes a water tank, a conduit configured to supply water from the water tank, and a water heater configured to heat the water supplied along the conduit. A water retention system provided in the water supply system includes a return line for selectively recirculating the water from the conduit to the water tank. A temperature sensor provided on the return line measures a temperature of the water recirculating along the return line. The water recirculates until a suitable temperature is reached.

### CROSS-REFERENCE TO RELATED APPLICATION(S)

This application claims priority to and the benefit of U.S. Provisional Ser. No. 63/688,551 , filed Jul. 8, 2024, the entirety of which is incorporated herein by reference.

### TECHNICAL FIELD

The present subject matter relates generally to recreational vehicles, and to water systems for recreational vehicles.

### BACKGROUND

There are over 300,000 recreational vehicles (RVs) sold annually in the United States. The majority of these vehicles are equipped with a water storage system and most are equipped with a water heating system. While many campgrounds include water hookups, there are two growing trends that are pertinent to water usage in RVs. First, consumers are desiring ways to use less water for conservation and environmental purposes. Second, it is often desirable to conserve water within a water storage system, as many RV users travel to places that are “off-grid,” without ready access of clean water. Therefore, it can be desirable to conserve as much fresh water as possible.

### BRIEF DESCRIPTION OF THE DRAWINGS

A full and enabling disclosure, including the best mode thereof, directed to one of ordinary skill in the art, is set forth in the specification, which makes reference to the appended figures, in which:

FIG. 1 is a schematic view of a water supply system for a recreational vehicle including a water retention system, in accordance with an aspect of the disclosure.

FIG. 2 is a schematic view of the water retention system of FIG. 1, in accordance with an aspect of the disclosure.

FIG. 3 is a flow chart illustrating a method of conserving water in a water supply system for a recreational vehicle, in accordance with an aspect of the disclosure.

### DETAILED DESCRIPTION

One opportunity for water to be wasted in an RV system is the residual hot water that has cooled in supply lines between uses. More specifically, the user operates a faucet at a warm or hot temperature setting, but cool or cold water is still dispensed until the warmed water reaches the faucet. This cool water that is dispensed is the result of the residual hot water in the supply lines that cools between uses of the hot water. This cooled water is often wasted as consumers are waiting for the hot water to reach the faucet outlet. For example, the user simply allows the running water to drain while waiting for the water temperature to increase. This practice results in a wasted volume of water each time usage of warm or hot water is desired. This wasted water increases the amount of water collected in storage systems, like gray water storage systems, which increases the frequency of water dumping. Such an increase in frequency is an inconvenience for the user, and creates a hassle emptying the gray water tank, particularly when the RV is not connected to a sewer. Thus, there is a need for an inexpensive and simple way to recycle the unused water back into the storage system of the RV. There is an opportunity to conserve this residual water when using warmed or hot water supplies, which can improve user experience, as well as reduce water usage, reduce water contained in waste or storage systems, and reduce the frequency that a user needs to refill or dump the liquids.

The above problems are resolved by an improvement to the water supply system implemented in RVs. An electronically controlled valve, such as a valve connected to a T-fitting, can be located close to the point-of-use of hot water within an RV allows cooled water in the hot-water supply lines to be returned to the potable water storage system while those lines are replenished with heated water. Water moves through the lines using the existing water pressure system within the RV. In one implementation, this system would include a similar valve at each point-of-use within the RV. Example points of use include, but are not limited to, sinks, faucets, toilets, and showers, as well as other features that utilize water, such as appliances like washing machines or dishwashers. An alternative embodiment can use a single valve at a location in close proximity to multiple point-of-use fixtures.

Each electronically controlled valve can include a temperature sensor to detect when hot water has been replenished in the lines. Both the electronic control valve and temperature sensor can connect to a control unit. Hot water replenishment can be requested by a user through three optional control methods. In a non-limiting example, hot water replenishment can be requested by a user through a button that can be pressed for each valve unit in the system. Once pressed, the system will replenish hot water until a certain temperature is reached, while the existing cooled water in the system is recirculated to the water storage. In another non-limiting example, the electronically controlled valves an integration with “Recreational Vehicle-Canbus” (RV-C) protocol, which can permit manufacturers to integrate the control of the device into the RV within the electronics systems. In another non-limiting example, hot water replenishment can be requested via a Bluetooth Low Energy (BLE) connection to the control unit, or other local wireless communication systems. In each case, the valves and control unit can be placed out of view of the user within the RV to improve the aesthetics of the system. Providing this variety of control mechanisms is important to cover the wide range of end-user experiences that an RV manufacturer may desire. The end result of each hot water replenishment request will be a reduction in wasted water and an instant hot-water experience for the end user.

Furthermore, this system can be integrated into existing hot water supply systems. Many RVs uses ½″ (one-half inch) water supply lines and can provide 12V (volt) DC power to the control unit. Additional cold water return lines can be installed to connect to the water storage system. The routing of these lines has no bearing on the functionality of the system, and RV manufacturers can route the lines in a manner that is most efficient for the specific RV or design thereof. Additionally, the system can be installed as an after-market addition to an existing RV.

Aspects of the disclosure herein are directed to a water recirculation circuit for a recreational vehicle or other vehicle with a water storage system or other water system. It will be understood, however, that aspects of the disclosure herein are not so limited and may have general applicability within other mobile water circulation applications.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a,” “an,” and “the” include plural references unless the context clearly dictates otherwise. Furthermore, as used herein, the term “set” or a “set” of elements can be any number of elements, including only one.

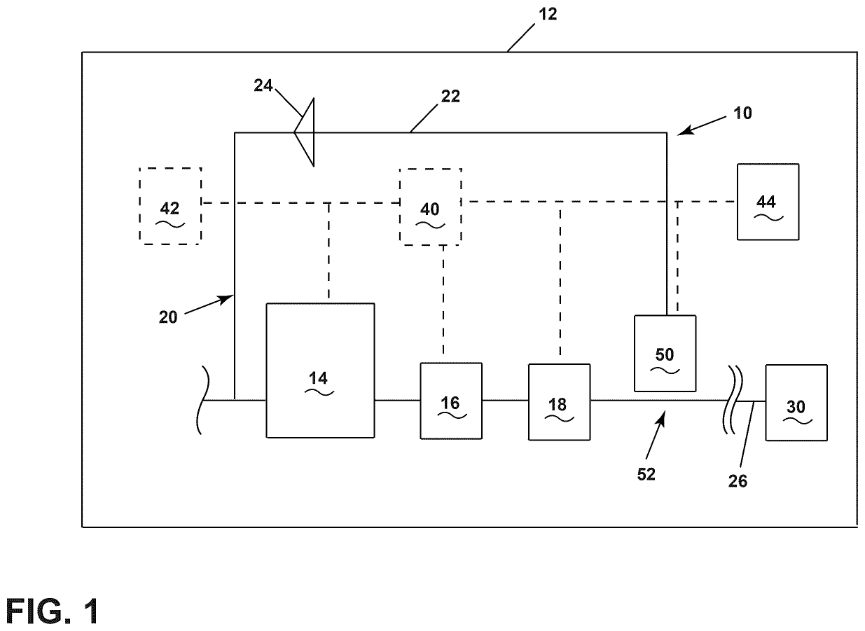

FIG. 1 illustrates a schematic view of a water supply system 10 for use within a vehicle, such as a recreational vehicle (RV) 12. The water supply system 10 can include a water tank 14 which can hold available potable water for use within the RV. A pump 16 is operably coupled within the water supply system 10 to pump water from the water tank 14 through the water supply system 10. A water heater 18 is included within the water supply system 10 to heat water from the water tank 14.

The water supply system 10, as well as the water tank 14, the pump 16, and the water heater 18 are connected with a set of conduits 20. The set of conduits 20, for example, can be one-half-inch water lines, while any size conduit suitable for use within the particular supply system is contemplated. A return line 22 can return to the water tank 14 from downstream of the water tank 14 within the water supply system 10 to permit water provided from the water tank 14 to return to the water tank 14. A check valve 24 can be provided on the return line 22 to mitigate backflow. A fixture line 26 can connect the water supply system 10 to a fixture 30, which can be one or more fixtures 30. Non-limiting examples of fixtures 30 can include sinks, faucets, toilets, and showers, as well as other features that utilize water, such as appliances like washing machines or dishwashers.

A controller 40 can operably couple to one or more aspects or features of the water supply system 10, such as the water tank 14 (or sensor therein), the pump 16, the water heater 18, as well as the vehicle or RV 12. In a non-limiting example, the controller 40 can be a microprocessor-based controller that implements control software and sends/receives one or more electrical signals to/from each of the various working components to implement the control software. As an example, proportional control (P), proportional integral control (PI), and proportional derivative control (PD), or a combination thereof, a proportional integral derivative control (PID), can be used to control the various components of the water supply system 10. The controller 40 can include a processor and memory to store and execute software or instructions relating to control the operation of the water supply system 10. In a non-limiting example, the vehicle or RV carrying the water supply system 10 is often integrated with its own software or system, like a RV bus 42, such as the RV-C protocol, or a primary control board for the RV 12. The controller 40 can be a part of such a system, or the controller 40 can be operably and communicatively coupled to such a system.

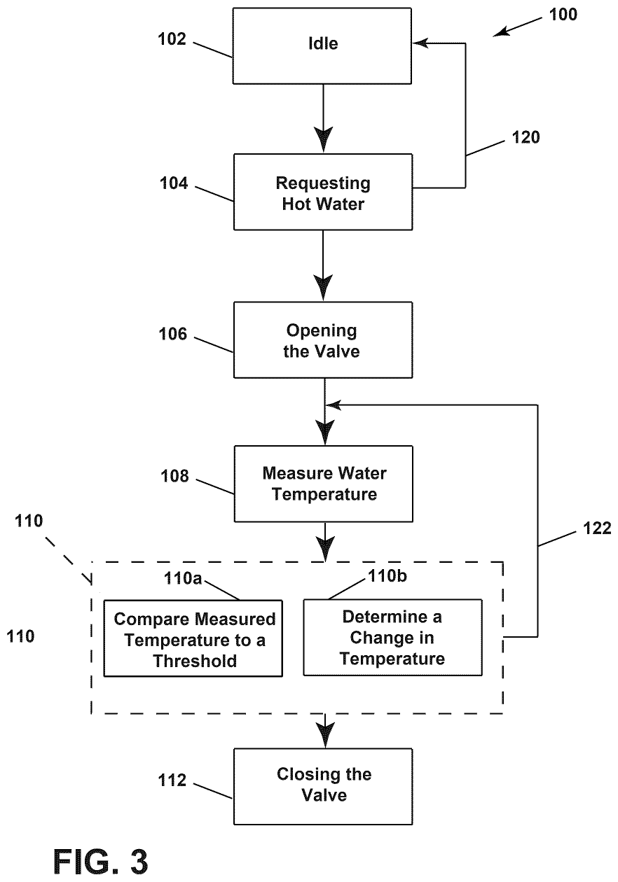

An actuator or switch 44 can operably couple to the controller 40. The switch 44 can be positioned remote from the controller 40, such as near the fixture 30. The number of switches 44 can be equal to the number of water retention systems 50 included in the system, which can be equal to the number of fixtures 30. In alternative, non-limiting examples, more than one switch can be associated with one water retention system 50 or one fixture 30, or multiple fixtures or water retention systems 50 can be associated with a single or common switch 44. In additional non-limiting examples, the switches 44 can be installed anywhere in the RV at the discretion of the RV manufacturer. In an alternative, non-limiting example, controller 40 can interface with an existing control system within the RV 12, such as connecting to the RV bus 42. In such an example, the RV bus 42 or other onboard system can initiate a water recycling sequence (like that of FIG. 3) using specified commands for the control board.

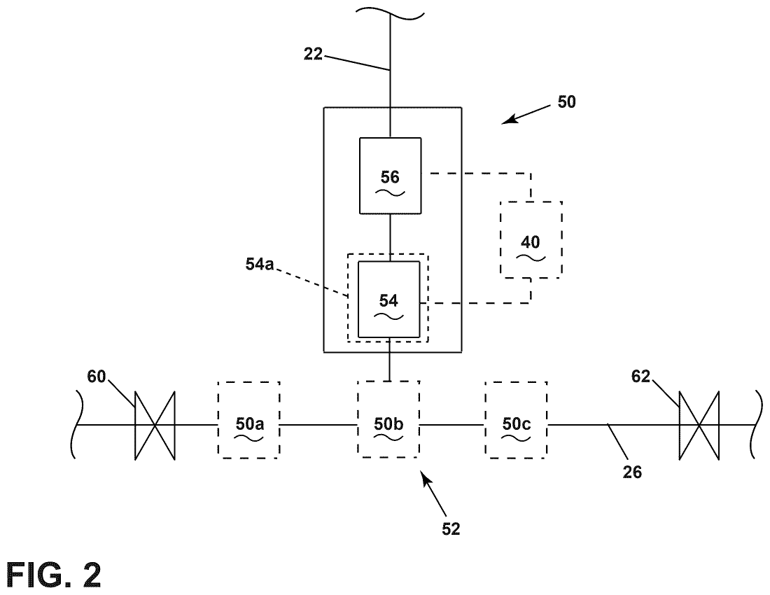

A water retention system 50 is provided within and fluidly connected with the water supply system 10, and can operably couple to the controller 40. A junction 52, or T-junction, can be defined by the set of conduits 20. The water retention system 50 can be positioned downstream of the junction 52, while alternative arrangements are contemplated, such as arrangements between the junction 52 and the fixture 30, or upstream of the junction 52 in non-limiting examples. (See FIG. 2, for example). One water retention system 50 can be connected to each point-of-use or each fixture 30, and each water retention system 50 can connect to the controller 40, while individual dedicated controllers at each water retention system 50 are contemplated.

FIG. 2 shows an enlarged view of the water retention system 50 positioned along the return line 22. The water retention system 50 can include a valve 54 and a temperature sensor 56, each of which can be communicatively and operatively coupled to the controller 40. The valve 54 can selectively provide access to the return line 22. The temperature sensor 56 can measure the temperature of liquid passing within the return line 22, and can provide a signal to the controller 40 representative of the temperature of the liquid within the return line 22.

While the water retention system 50 is shown positioned along the return line 22, it is contemplated that the water retention system 50 can be provided upstream of the junction 52 as shown at 50a, at the junction 52 as shown at 50b, or downstream of the junction 52 as shown at 50c, such as along the fixture line 26. In another non-limiting example, one or more additional valves can be provided along the water supply system 10. For example, a secondary valve 60 can be provided at the set of conduits 20 upstream of the junction 52, a secondary valve 62 along the fixture line 26 downstream of the junction 52, or even a secondary valve positioned at the junction 52. The secondary valves 60, 62 can be coupled to the controller 40, for example, and can be selectively opened and closed to provide water to the fixture 30 (FIG. 1).

In an alternate, non-limiting example, the valve 54, or the water retention system 50, can include a recirculation pump 54a. That is, the valve 54 can be replaced with the recirculation pump 54a. In another non-limiting example, the valve 54 can incorporate a recirculation pump 54a, or the recirculation pump 54a can have an integrated valve system. In some systems, there may be no fresh water tank, or it can be desirable or advantageous to recirculate the water within the system until a suitable temperature has been reached, without returning the water to the water tank 14 or other water storage system.

In operation, a supply of water can be supplied along the set of conduits 20 from the water tank 14 (FIG. 1), which can be pumped by the pump 16 (FIG. 1). The water can be heated by the water heater 18 (FIG. 1) for a supply of heated water to the fixtures 30. In one example, hot water can be requested by actuating the switch 44 (FIG. 1). Actuation of the switch 44 can begin movement of the water along the water supply system 10, such as by operation of the pump 16. More specifically, actuation of the switch 44 can cause the pump 16 to begin to move water along the set of conduits 20, and recirculate to the water tank 14 along the return line 22. During such a recirculation, the water can be heated by the water heater 18, increasing the temperature of the water. The temperature of the water can be measured by the temperature sensor 56. When the temperature of the water reaches a suitable temperature, the heated water can be supplied to the fixtures 30, such as by closing the valve 54, or opening of the secondary valve 62 along the fixture line 26, or both.

In this way, the relatively cooler water residing within the set of conduits 20 downstream of the water heater 18 is recirculated to the water tank 14, and can be conserved until the temperature of the water heated by the water heater 18 reaches a particular temperature. Such a recirculation conserves the existing water within the set of conduits 20, rather than being drained or wasted while the user at the fixture 30 waits for the heated water to reach the fixture 30.

Where the system includes the recirculation pump 54a, the flow of water can be recirculated among the return line 22, recirculating the water within the system until a suitable temperature as measured by the temperature sensor 56 is determined. After a suitable temperature has been reached, the recirculation pump 54a can cease operation, or close a related valve, to permit the heated water to pass to the fixture 30.

FIG. 3 is a flow chart depicting a method 100 of conserving water for a recreational vehicle (RV). The method 100 can be executed by the controller 40 of FIGS. 1-2, for example. At 102, the method 100 can include where the water supply system, like the water supply system 10 of FIG. 1, can remain unused or at idle, where a volume of residual liquid remains within the set of conduits 20 between uses of a fixture, like the fixture 30 of FIG. 1.

At 104, the method 100 can include requesting hot water. Such a request, for example, can initiate by actuation of a button or switch, like the switch 44 of FIG. 1. In a non-limiting example, such a request can be initiated by attempting to use the fixture itself. For example, where a user operates the hot water at a sink-type fixture, and such an operation of the faucet can request the heated water. In such an example, the faucet, fixture, hot water faucet, or other aspects thereof, can be operatively and communicatively coupled to a controller, like the controller 40 of FIGS. 1-2, which can couple to the water retention system 50. In another non-limiting example, a request for hot water can be a signal relayed to the water retention system 50 or controller 40 via an electronics system, and need not be limited to a physical request, like that of actuating the switch 44 or the fixture 30.

The request for hot water can include instructions, via the controller 40, to the pump 16 and the water heater 18, to begin both moving the supply of water along the water supply system 10 to the return line 22. The water heater 18 begins to heat this supply of water moving to the return line 22.

At 106, the method 100 includes opening the valve, where the valve 54 (FIG. 2) for the water retention system 50 is opened, opening access to the return line 22 at the water retention system 50. When the valve 54 is opened, water pumped and heated along the water supply system 10 by the pump 16 and water heater 18 is permitted to pass to the return line 22, while existing water within the set of conduits 20 and the return line 22 can recirculate and return to the water tank 14.

At 108, the method 100 can include where the temperature sensor 56 measures the water temperature of the water passing through the valve 54 along the return line 22. The temperature sensor 56 generates a signal representative of the measured temperature of the water, which can be provided to the controller 40. In a non-limiting example, the measured temperature can be measured as a change in temperature or a change in temperature over time. For example, as the water heater 18 increases the temperature, the increase in temperature can be measured and provided to the controller 40.

At 110, the method 100 can include comparing the measured temperature, or the change in temperature, with temperature data or information stored at the controller 40. In a non-limiting example, at 110a, the method 100 can include comparing the measured temperature to a threshold temperature. The controller 40 can determine if the water has reached a particular temperature. More specifically, the controller 40 can compare the measured temperature to a threshold temperature to determine if the water has been heated to a suitable temperature. The valve 54 can remain open, permitting water to recirculate along the water supply system 10 via the return line 22, until the water reaches the threshold temperature or a predetermined temperature. For example, the predetermined temperature can be programmed into the controller 40 or until a preset timeout has been reached. The timeout provides a fail-safe in the event that the system is not cycling water, for example.

In another non-limiting example, the method 100 at 110b can include determining a change in temperature by comparing the measured temperature to a prior temperature. For example, as the temperature increases, the increase in temperature can be determined by performing at least two measurements. The change in temperature can be compared to a predetermined change in temperature in order to determine if the temperature has suitably increased. More specifically, a first initial temperature can be measured, and then at a later time, a second temperature can be measured. The controller 40 can compare the first initial temperature to the second temperature to determine an increase in temperature. Once the increase in temperature reaches a particular value, such as a threshold, then the method 100 can move to 112. In a non-limiting example, the temperature change can be a five-degree increase in temperature.

At 112, the method 100 can include closing the valve 54 on the return line 22. After the measured temperature reaches the threshold temperature, as measured by the temperature sensor at 108 and compared with the threshold temperature by the controller 40 at 110, then the heated water can be supplied to the fixture 30. More specifically, the valve 54 can be closed after the water temperature has reached the threshold temperature, permitting the heated water to pass to the fixture 30 along the fixture line 26. It should be appreciated that the fixture line 26 may remain closed at the fixture 30 until utilized by a user at the fixture 30. More specifically, maintaining the fixture line 26 being closed at the fixture 30 permits the water to recirculate to the return line 22 while waiting for the temperature to reach the temperature threshold. Where circumstances prevent closing the return line 22, or make doing so difficult, it is contemplated that an additional valve, like the secondary valve 62, can be selectively closed to permit recirculation along the return line 22 until the water temperature reaches the temperature threshold.

At 120, the method 100 can include a timeout feature. The timeout feature can be a measured time from a request for hot water, such as by actuating the switch 44, and begin a timer. Such a timer may be implemented at the controller 40, for example. When the timer reaches a particular timeout value, the timeout feature can cause the pump 16 and water heater 18 to cease requesting of hot water and return to an idle state at 102. In a non-limiting example, the timeout feature can be one minute, while any time is contemplated.

At 122, the method 100 can include repeating measuring of the water temperature at 108 and comparing the measured water temperature to the threshold temperature. Where the measured water temperature does not reach the temperature threshold, the requested water at the fixture 30 will not have reached a suitable temperature. The water can continue to recirculate along the return line 22, and the water retention system 50 can continually or periodically measure the water temperature until the measured temperature reaches the temperature threshold, where the water is then permitted to pass to the fixture 30 and the valve 54 can be closed.

The apparatus, system, and method as described herein provides a system that recirculates existing cooled water within the water supply system while waiting for heated water to reach a fixture. This recirculation conserves water within an isolated water system with a limited supply of water. Such a conservation can be desirable by a user, and reduces the occurrence of refilling the water tank, or emptying the sewer.

Implementation of the aspects described herein may be incorporated or installed with an existing vehicle or RV, such as being installed by a manufacturer during manufacture. Alternatively, the aspects may be provided as a unit for later installation and use with existing water systems, or can be separated out as individual components.

To the extent not already described, the different features and structures of the various aspects can be used in combination with each other as desired, or can be used separately. That one feature can not be illustrated in all of the aspects is not meant to be construed that it cannot be, but is done for brevity of description. Thus, the various features of the different aspects can be mixed and matched as desired to form new aspects, whether or not the new aspects are expressly described.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects are provided by the subject matter of the following clauses:

A water supply system for a recreational vehicle, the water supply system comprising: a water tank; a conduit configured to supply water from the water tank; a water heater configured to heat the water supplied along the conduit; a return line extending from the conduit to the water tank; a valve for selectively recirculating the water from the conduit to the water tank along the return line; and a temperature sensor provided on the return line and configured to measure a temperature of the water recirculating along the return line.

The water supply system of any preceding clause, wherein the valve is provided on the return line.

The water supply system of any preceding clause, further comprising a switch operably coupled to the valve.

The water supply system of any preceding clause, further comprising a controller operably coupling the valve to the switch.

The water supply system of any preceding clause, further comprising a pump fluidly coupled to the conduit and configured to pump water from the water tank.

The water supply system of any preceding clause, wherein the controller is configured to operate the valve to cease recirculating water when the temperature sensor measures a temperature that reaches a temperature threshold.

The water supply system of any preceding clause, wherein the switch is configured to open the valve until the temperature sensor measures the temperature that meets or exceeds the temperature threshold.

The water supply system of any preceding clause, further comprising a fixture configured to receive the supply of water from the water tank via the conduit.

The water supply system of any preceding clause, further comprising a fixture line coupling the fixture to the conduit.

The water supply system of any preceding clause, further comprising a secondary valve for selectively coupling the fixture to the conduit.

A method of conserving water in a recreational vehicle, the method comprising: heating a supply of water within a water supply system with a water heater; measuring a temperature of the supply of water to determine a water temperature or a change in temperature; comparing the water temperature or the change in temperature to a threshold temperature; and recirculating the supply of water within the water supply system until the water temperature meets or exceeds the threshold temperature heated by the water heater.

The method of any preceding clause, further comprising requesting hot water from the water supply system.

The method of any preceding clause, wherein requesting hot water includes actuating a switch.

The method of any preceding clause, further comprising opening a valve in a water retention system to permit recirculating of the supply of water.

The method of any preceding clause, wherein the valve is positioned on a return line.

The method of any preceding clause, wherein recirculating further comprises providing the supply of water to a water tank from the return line.

The method of any preceding clause, further comprising closing the valve after the water temperature meets or exceeds the threshold temperature.

The method of any preceding clause, further comprising dispensing the water from a fixture.

The method of any preceding clause, wherein a controller coupled to a temperature sensor is configured to compare the water temperature to the threshold temperature.

The method of any preceding clause, further comprising ceasing heating of the supply of water after reaching a timeout value.

What is claimed is:

1. A water supply system for a recreational vehicle, the water supply system comprising:
a water tank;
a conduit configured to supply water from the water tank;
a water heater configured to heat the water supplied along the conduit;
a return line extending from the conduit to the water tank;
a valve for selectively recirculating the water from the conduit to the water tank along the return line; and
a temperature sensor provided on the return line and configured to measure a temperature of the water recirculating along the return line.

2. The water supply system of claim 1, wherein the valve is provided on the return line.

3. The water supply system of claim 1, further comprising a switch operably coupled to the valve.

4. The water supply system of claim 3, further comprising a controller operably coupling the valve to the switch.

5. The water supply system of claim 4, further comprising a pump fluidly coupled to the conduit and configured to pump water from the water tank.

6. The water supply system of claim 4, wherein the controller is configured to operate the valve to cease recirculating water when the temperature sensor measures a temperature that reaches a temperature threshold.

7. The water supply system of claim 6, wherein the switch is configured to open the valve until the temperature sensor measures the temperature that meets or exceeds the temperature threshold.

8. The water supply system of claim 1, further comprising a fixture configured to receive the supply of water from the water tank via the conduit.

9. The water supply system of claim 8, further comprising a fixture line coupling the fixture to the conduit.

10. The water supply system of claim 9, further comprising a secondary valve for selectively coupling the fixture to the conduit.

11. A method of conserving water in a recreational vehicle, the method comprising:
heating a supply of water within a water supply system with a water heater;
measuring a temperature of the supply of water to determine a water temperature or a change in temperature;
comparing the water temperature or the change in temperature to a threshold temperature; and
recirculating the supply of water within the water supply system until the water temperature meets or exceeds the threshold temperature heated by the water heater.

12. The method of claim 11, further comprising requesting hot water from the water supply system.

13. The method of claim 12, wherein requesting hot water includes actuating a switch.

14. The method of claim 11, further comprising opening a valve in a water retention system to permit recirculating of the supply of water.

15. The method of claim 14, wherein the valve is positioned on a return line.

16. The method of claim 15, wherein recirculating further comprises providing the supply of water to a water tank from the return line.

17. The method of claim 14, further comprising closing the valve after the water temperature meets or exceeds the threshold temperature.

18. The method of claim 17, further comprising dispensing the water from a fixture.

19. The method of claim 15, wherein a controller coupled to a temperature sensor is configured to compare the water temperature to the threshold temperature.

20. The method of claim 11, further comprising ceasing heating of the supply of water after reaching a timeout value.
